(19) United States
(12) Patent Application Publication
(10) Pub. No.: US 2009/0234691 A1
(43) Pub. Date: Sep. 17, 2009

(54) System and method of assessing qualitative and quantitative use of a brand

(76) Inventors: Ryan Steelberg, Irvine, CA (US); Chad Steelberg, Newport Beach, CA (US)

Correspondence Address: Thomas J. McWilliams, Esquire;Drinker Biddle & Reath LLP, One Logan Square, 18th & Cherry Streets, Philadelphia, PA, 19103-6996, US

(21) Appl. No.: 12/322,940

(22) Filed: Feb. 9, 2009

Related U.S. Application Data
(60) Provisional application No. 61/065,297, filed on Feb. 7, 2008.

(51) Int. Cl. G06Q 10/00; G06F 17/30

(52) U.S. Cl. 705/7; 707/104.1; 707/E17.045

(57) ABSTRACT

A system and a method for determining the quantitative and qualitative rating of a brand using keywords. The software, system, and method include receiving a first set of the keywords associated with the brand, receiving at least two inputs at at least one regular time interval, wherein a first of the at least two inputs includes a media type and a use of a second set of keywords, and wherein a second of the at least two inputs includes a media type and a use of a third set of keywords, calculating the number of occurrences of the first set of keywords in at least the second set of keywords and the third set of keywords, and storing the occurrences in association with at least one index.

### BACKGROUND OF THE INVENTION

1. Field of the Invention

The present invention relates generally to brand usage, and more specifically, provides a system, software and a method of assessing qualitative and quantitative use of a brand.

2. Description of the Background

Brands, such as brands of goods, services, and people, and more specifically keywords associated with brands, are in use across every available media, every minute of every day. Some of these uses constitute advertising by the brand of interest. However, other uses constitute critiques of brands, competitive statements regarding brands, consumer discussion of brands, and the like, that are not paid for by any party associated with the brand of interest.

Although keyword searches are presently available in certain media, such as the Internet, such searches are not presently available in all media, such as for television or radio uses. In light of the fact, discussed above, that a brand only can be aware of uses of the keywords associated with that brand in the event that the brand places an advertisement and receives a confirmation that the subject advertisement was placed or played, it would be advantageous to have available to that brand a keyword search that would return all uses of the keywords associated with that brand across one or more media, in a qualitative and quantitative measure of such uses. Further, it would be advantageous if such a search could be requested by those associated with, or interested in, a certain brand, to occur at regular timeframes in an automated manner.

Thus, the need exists for software, a system and a method of searching for keywords associated with a brand across one or more media, and thereby assessing qualitative and quantitative use of those keywords associated with that brand.

### SUMMARY OF THE INVENTION

The present invention includes software, a system and a method for determining the quantitative and qualitative rating of a brand using keywords. The software, system, and method include receiving a first set of the keywords associated with the brand, receiving at least two inputs at at least one regular time interval, wherein a first of the at least two inputs includes a media type and a use of a second set of keywords, and wherein a second of the at least two inputs includes a media type and a use of a third set of keywords, calculating the number of occurrences of the first set of keywords in at least the second set of keywords and the third set of keywords, and storing the occurrences in association with at least one index. The invention may additionally include, for example, assessing the qualitative use of each of the occurrences, and storing the qualitative use in association with the respective one of the occurrences and the at least one index.

Thus, the present invention provides software, a system and a method of searching for keywords associated with a brand across one or more media, and thereby assessing qualitative and quantitative use of those keywords associated with that brand.

### DETAILED DESCRIPTION OF THE INVENTION

The present invention is and includes software for determining the quantitative and qualitative rating of a brand, B, from a given set of brands. The ratings determined may be indexed by at least one of time, geography, demographics, or other index factors as may be apparent to those skilled in the art based on the discussion herein.

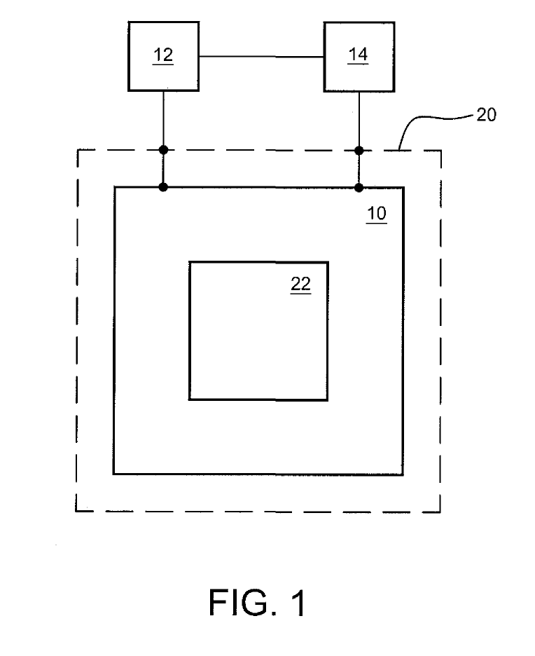

The software 10 of the present invention, also referred to herein as a “program” or a “system,” is most preferably associated and interoperable with computing hardware as illustrated in FIG. 1. The computer hardware includes at least one microprocessor 12 having associated therewith one or more memory or storage devices 14, such as, but not limited to, random access memory (RAM), read only memory (ROM), and other types of memory, such as EEPROM, as may be known to those skilled in the art. The program may run on or in association with one or more operating systems 20, as will also be apparent to those skilled in the art. Such operating systems may be those typically associated with computers, televisions, radio broadcast generation, and mobile computing devices, such as telephones and personal digital assistants. Further, the program may present inputs and outputs in a graphical-user-interface format (GUI) 22, which GUI may or may not be dependent on the aforementioned operating system. The GUI preferably allows for interaction with or manipulation of the program, and specifically the program inputs or outputs, by one or more users of the program.

The program is and includes multiple lines of computing code, which, when executed by the one or more microprocessors in accordance with instructions received via the GUI, draw information from the memory devices, or from external memory links or locations, to perform the steps discussed herein. The overarching steps provide, for a given a set of brands B, a determination of the quantitative and qualitative rating of each B, indexed by at least one or more of time, geography, and demographics.

More specifically, B is defined by a brand name or set of names. The variable set B may be stored in a database, table, or the like, which database, table or the like may be relational in nature, and which database, table or the like may be locally or remotely associated with, or form part of, the aforementioned one or more memory or storage devices. Similarly, D is defined by a domain or set of domains stored in a database, table or the like. Domain(s) D may be platform or media types, or domains within a particular media type, such as Internet domains. For example, a D may be a television or radio station in Los Angeles, or an Internet domain. Domain(s) D are preferably associated with various designated market areas (DMA), daily impressions, and/or demographic statistics, for example.

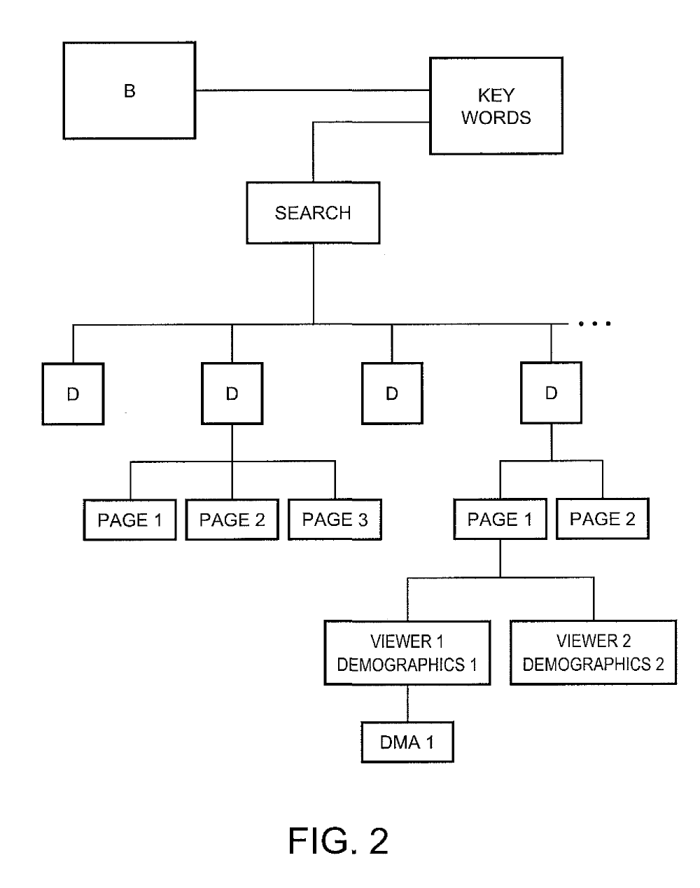

In any selected time frame, such as per hour, per day, per month, or per year, for example, B may receive a quantitative rating based on D. The quantitative rating may be perceived using any of a number of factors as shown in FIG. 2, such as, for example, in an exemplary networked environment, measuring the number of networked pages (URLs) and/or estimated networked page views (page impressions) per time frame per B, page or views segmented by DMA, and/or by demographics. Demographics may include, for example, age, race, income range, religious affiliation, purchase habits, or the like, for example.

It goes without saying that the “number of pages,” or “estimated page views,” may be readily replaced by similar measurements in non-networked media, such across other platforms or in other media types, such as: audio references on mobile devices, radio, television or movies; video references on mobile devices, television or movies; and/or print or text references in print, on mobile devices, on television or in movies. In such additional and alternative embodiments of the present invention, various technologies may be employed in order to assess the referenced usages, such as, but not limited to, data, video, and audio capturing; text/OCR scanning; digital data/text, audio and video fingerprinting; watermarking, and the like. Usage in such networked and non-networked technologies may be quantitatively and qualitatively tracked through the use of the present invention, either individually or in any combination of two or more networked or non-networked technologies, as will be readily understood to one skilled in the pertinent arts in light of the disclosure herein.

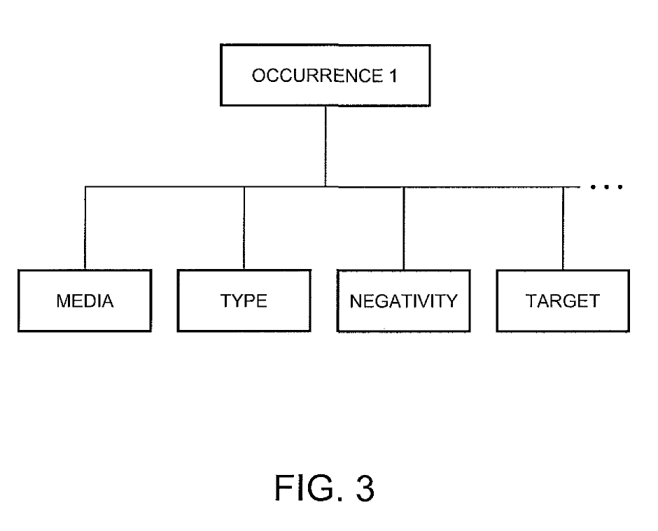

In any selected time frame, such as per hour, per day, per month, or per year, for example, B may also receive a qualitative rating. The qualitative rating may, such as for a given quantitative measure as shown in FIG. 3, measure the context of the quantitative measure as it relates to the B per time frame. Context may include on or more of, for example, the type of use, the media of use, the platform of use, whether the use is supportive or negative, the target audience of the use, and any like measures.

The quantitative and/or qualitative measures, and/or the data associated therewith, may be viewed, locally or remotely, via, for example, a graphical user interface (GUI). The GUI may be available via a network, such as the Internet, an intranet, or an extranet, for example. The GUI may be available via or within a web browser, for example. The GUI may display the measures in any known format, such as graphical or tabular format, for example. The measures may be displayed in raw or normalized form, for example.

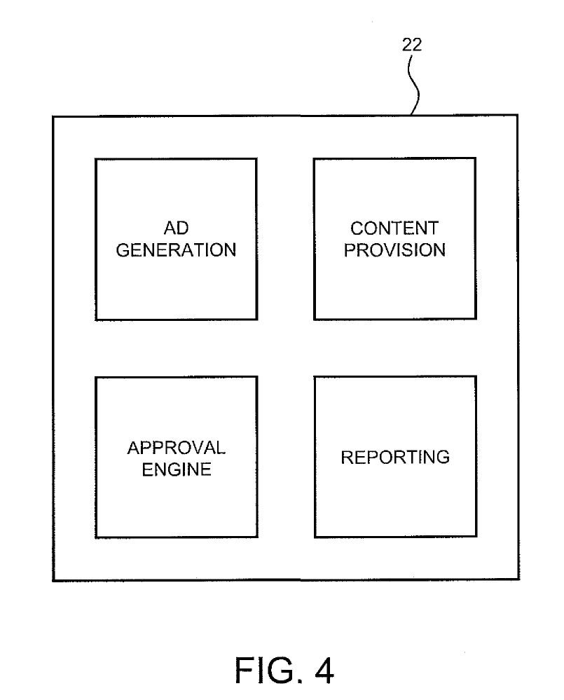

The GUI may also be and include a series of advertising templates for different targeting, and a clearinghouse that allows for the use of approved, copyrightable, and/or public persona content by non-owners of such content. The GUI may additionally provide for the use of use-context and brand recognition to create brand affinity. The GUI may thus include at least an advertisement/endorsement generation interface, a content provision interface, an approval engine interface, and the aforementioned reporting interface, as is illustrated with respect to FIG. 4.

The ad generation interface may provide the capability for a user to create an advertisement, announcement, data file, or the like for targeting a certain market, or use in a certain platform or media, and/or for association with an endorser, affiliate, affiliated product, or the like. The ad generation interface may provide, for example, a multiplicity of advertisement templates, from among which a user may select a desired advertisement format or a format suggested as best-suited for a particular target.

The content provision interface may be accessible to a content providing user. The content provision interface may allow for the selection by a content provision user of what usages and approvals for usage will be allowable for the content made available by the content provision user. The content provided by the content provision user may be entered directly for storage through the content provision interface by the content provision user, or may be provided via a link to the content, which link is external to the content provision rules engine and interface, but which link may allow the content rules engine to draw the content from any source in any format.

The approval engine interface provided to a content provision user may allow for advertisements requested by users of the ad generator to be forwarded back to the content provider for a variety of reasons, including final approval, tracking, and reporting. For example, certain advertisements or endorsements may be automatically approved based on an adherence to the rules entered into the content provision rules engine. Additionally or alternatively, requested endorsements or affiliations meeting certain criteria may be forwarded back to the content provider, or all requests may be forwarded back to the content provider, for final approval.

The reporting interface of the GUI may report on one or more of the activities occurring within or in association with the aforementioned interfaces, and may further provide the reporting, in any known format, of the quantitative and qualitative measures discussed hereinabove. Thus, for example, reports may issue based on media of use, type of use, amount of use, or any other quantitative or qualitative use measure of one or more of the keywords predetermined to be associated with the brand (B) of interest. Further, for example, different reports may be available for different combinations of a certain set of keywords.

In an exemplary embodiment of the software, system and method of the present invention, a list of brands (B) may be stored in a database associated with a computerized memory. Each B may be associated with one or more of various keywords. For example, if B is the country singer Kenny Rogers, associated keywords might include ‘Kenny”, “Rogers”, “Music”, “Country”, or “Gambler.” Weighting may be assigned for different combinations of these keywords. For example, “Kenny Rogers” and “Country Music” may receive a maximum weighting as an exact match use, and thus clearly a reference to the brand B of interest, while “Rogers” and “Gambler” in a combined use may receive a lower weighting because, while the use quite likely relates to the brand B of interest, a matching use is not as certain as in the prior case.

A list of domains (D) may be stored in the database with B, or in a different database. Each D may be associated with various parameters, such as DMA coverage, page views per day, demographics, and the like.

The software, system and method then iterates, either continuously or at a predetermined batch time, through all keyword assigned to B. This iteration may occur anew at a given time interval, such as once per hour. More specifically, the search query preferably seeks the use of B's keywords online in a given timeframe, and may seek the use of such keywords in the weighted combinations discussed hereinabove. The search may be performed by any known search or crawl methodology for searching the Internet, such as searching using a known search API, such as Google®'s search API.

In exemplary embodiments, the search of the present invention filters for, and thus may eliminate if so set by the user requesting a reporting, keyword use in advertising placed by B itself, such as ads placed by an ad engine, and more specifically such as ads placed by Google® advertising. The present invention may additionally also filter for illegal or improper usage, and may, in fact, separately track such illegal or improper uses in addition to the keyword tracking.

Search results may be stored in any known medium, according to any known format, and may include as much or as little detail regarding the usage as is desired by a user. For example, the present invention may store the search results in one or more of the previously referenced databases, or in a unique database, and the results stored may include any numbers of details regarding the usage, such as the abstract text used and/or the URL of usage. The results stored may be linked to B and may be timestamped, for example.

Based on this data, a number of quantitative and qualitative measures may be made. For example with regard to Internet use inquiries, the total unique URL's returned per B per time frame may be assessed and similarly stored in the database. The total hits per D per time frame, such as per day, may be found, thereby allowing for the generation of brand per domain metrics. For each D, the DMA coverage map, demographic maps or breakdown, and the like may be computed, such as for each B, such as by cross referencing the keyword search result domains and the D.

An operator of the GUI, and/or of the software, system and method of the present invention, may interact with the search of the present invention while the search is ongoing. For example, as the program of the present invention runs, an operator may manually add additional D to expand coverage, which addition may be based on preliminary search results displayed to the operator by the GUI in real time as the search is ongoing.

1. A method for determining the quantitative and qualitative rating of a brand using keywords, comprising:
receiving a first set of the keywords associated with the brand;
receiving, over a computerized communications network, at least two inputs at at least one regular time interval, wherein a first of the at least two inputs comprises computer data indicative of a media type and a use of a second set of keywords, and wherein a second of the at least two inputs comprises computer data indicative of a media type and a use of a third set of keywords;
calculating the number of occurrences of the first set of keywords in at least the second set of keywords and the third set of keywords;
storing in at least one computerized memory the occurrences in association with at least one index;
assessing the qualitative use of each of the occurrences, wherein said assessing is performed by at least one processor; and
storing in the at least one computerized memory the qualitative use in association with the respective one of the occurrences and the at least one index.

2. The method of claim 1, wherein the at least one index comprises at least one selected from the group consisting of time, geography, and demographics.

3. The method of claim 1, further comprising providing for viewing via a graphical user interface of at least the first set of keywords, the number of occurrences, and the qualitative use.

4. The method of claim 3, wherein said receiving a first set of keywords comprises receiving the first set of keywords from the graphical user interface.

5. The method of claim 1, wherein said at least one computerized memory further comprises development of at least one database.

6. The method of claim 5, wherein the database is at least one relational database.

7. The method of claim 1, wherein the number of occurrences comprises occurrences in a domain.

8. The method of claim 7, wherein the domain comprises a domain within the media type.

9. The method of claim 7, wherein the domain comprises a platform.

10. The method of claim 1, wherein the domain is associated with at least one of a designated market area, a daily impression, and a demographic statistic.

11. The method of claim 1, wherein the regular time interval comprises one of an hour, a day, and a month.

12. The method of claim 1, wherein the number of occurrences comprises at least one of a number of networked pages and an estimated number of networked page views.

13. The method of claim 1, wherein the number of occurrences comprises spoken occurrences on a television station.

14. The method of claim 1, wherein the number of occurrences comprises spoken occurrences on a radio station.

15. The method of claim 1, wherein the number of occurrences comprises downloads to a mobile device.

16. The method of claim 1, wherein the qualitative use comprises a context.

17. The method of claim 16, wherein the context comprises at least one of a type of use, a media of use, a platform of use, a negativity of use, and a target audience of use.

18. The method of claim 1, wherein combinations of the first set of keywords are weighted.

19. The method of claim 1, wherein the regular time interval comprises continuously.

20. The method of claim 1, further comprising filtering from the number of occurrences at least one of a requested occurrence, and illegal occurrence and an improper occurrence.

21. An apparatus for determining the quantitative and qualitative rating of a brand using keywords, said apparatus comprising:
a receivor for receiving a first set of keywords associated with a brand;
a first input received at at least one regular time interval, said first input including computer data indicative of a media type and a second set of keywords;
a second input received at said at least one regular time interval, said second input including computer data indicative of a media type and a third set of keywords;
a processor for assessing a quantitative and qualitative rating, wherein said processor calculates the number of occurrences of the first set of keywords in at least the second set of keywords and the third set of keywords, stores the occurrences in association with at least one index, and thereby assesses the qualitative use of each of the occurrences; and
at least one computerized memory, associated with said processor, for storing the qualitative use in association with the respective one of the occurrences and the at least one index.

22. The apparatus of claim 21, wherein the at least one index comprises at least one selected from the group consisting of time, geography, and demographics.

23. The apparatus of claim 21, further comprising a graphical user interface for viewing of at least the first set of keywords, the number of occurrences, and the qualitative use.

24. The apparatus of claim 23, wherein said receivor receiving a first set of keywords comprises a receiver for receiving the first set of keywords from the graphical user interface.

25. The apparatus of claim 21, wherein the memory storing the occurrences comprises storing the occurrences in at least one database.

26. The apparatus of claim 25, wherein the database is at least one relational database.

27. The apparatus of claim 21, wherein the number of occurrences comprises occurrences in a domain.

28. The apparatus of claim 27, wherein the domain comprises a domain within the media type.

29. The apparatus of claim 27, wherein the domain comprises a platform.

30. The apparatus of claim 21, wherein the domain is associated with at least one of a designated market area, a daily impression, and a demographic statistic.

31. The apparatus of claim 21, wherein the regular time interval comprises one of an hour, a day, and a month.

32. The apparatus of claim 21, wherein the number of occurrences comprises at least one of a number of networked pages and an estimated number of networked page views.

33. The apparatus of claim 21, wherein the number of occurrences comprises spoken occurrences on a television station.

34. The apparatus of claim 21, wherein the number of occurrences comprises spoken occurrences on a radio station.

35. The apparatus of claim 21, wherein the number of occurrences comprises downloads to a mobile device.

36. The apparatus of claim 21, wherein the qualitative use comprises a context.

37. The apparatus of claim 36, wherein the context comprises at least one of a type of use, a media of use, a platform of use, a negativity of use, and a target audience of use.

38. The apparatus of claim 21, wherein combinations of the first set of keywords are weighted.

39. The apparatus of claim 21, wherein the regular time interval comprises continuously.

40. The apparatus of claim 21, further comprising a filter for filtering from the number of occurrences at least one of a requested occurrence, and illegal occurrence and an improper occurrence.

41. A method for determining the quantitative rating of a brand using keywords, comprising:
receiving a first set of the keywords associated with a brand;
receiving at least two inputs at at least one regular time interval, wherein a first of the at least two inputs comprises computer data indicative of a media type and a use of a second set of keywords, and wherein a second of the at least two inputs comprises computer data indicative of a media type and a use of a third set of keywords;
calculating the number of occurrences of the first set of keywords in at least the second set of keywords and the third set of keywords;
storing, in a computerized memory, the occurrences in association with at least one index; and
filtering from the number of occurrences at least one of a requested occurrence, an illegal occurrence and an improper occurrence.

42. A method for determining the qualitative rating of a brand using keywords, comprising:
receiving a first set of the keywords associated with a brand;
receiving at least two inputs at at least one regular time interval, wherein a first of the at least two inputs comprises computer data indicative of a media type and a use of a second set of keywords, and wherein a second of the at least two inputs comprises computer data indicative of a media type and a use of a third set of keywords;
assessing, via at least one processor, the qualitative use of each of the occurrences; and
storing in a database the qualitative use in association with the respective ones of the occurrences.
